(19) United States
(12) Patent Application Publication
(10) Pub. No.: US 2014/0358571 A1
(43) Pub. Date: Dec. 4, 2014

(54) HEALTHCARE SUPPORT SYSTEM AND METHOD FOR SCHEDULING A CLINICAL VISIT

(71) Applicant: KONINKLIJKE PHILIPS N.V., Endhoven (NL)

(72) Inventors: GIJS GELEIJNSE, GELDROP (NL); WILHELMUS JOHANNES JOSEPH STUT, EINDHOVEN (NL); ALEKSANDRA TESANOVIC, EINDHOVEN (NL); JAN JOHANNES GERARDUS DE VRIES, EINDHOVEN (NL)

(21) Appl. No.: 13/909,802

(22) Filed: Jun. 4, 2013

(51) Int. Cl. G06Q 50/22; G06Q 10/10

(52) U.S. Cl. CPC G06Q 50/22; G06Q 10/1095
USPC 705/2

(57) ABSTRACT

A healthcare support system and healthcare support method for scheduling a clinical visit of a patient are presented. The healthcare support system comprises a processor and a computer-readable storage medium, wherein the computer-readable storage medium contains instructions for execution by the processor, wherein the instructions cause the processor to perform the steps of obtaining clinical patient data descriptive of a clinical condition of the patient, obtaining psycho-social-assessment data of the patient, and scheduling a clinical visit for the patient based on said clinical patient data and said psycho-social-assessment data. Further, the present invention relates to a computer-readable non-transitory storage medium and a computer program. The proposed system assists in determining the need of a clinical visit, the urgency of a clinical visit and the nature of this visit in terms of required procedures and tests, topics to be discussed and professionals to be seen. Instead of purely relying on data descriptive of a clinical condition of the patient, a psycho-social-assessment is also considered.

### FIELD OF THE INVENTION

The present invention relates to a healthcare support system for scheduling a clinical visit of a patient comprising a processor and a computer-readable storage medium, wherein the computer-readable storage medium contains instructions for execution by the processor. Further, the present invention relates to a corresponding healthcare support method, a computer-readable non-transitory storage medium and a computer program.

### BACKGROUND OF THE INVENTION

The present disclosure relates to treating a patient and providing care to a patient. Currently, clinical visits are scheduled either well in advance or ad-hoc, when there is a significant deterioration in the patient's condition.

Typically patients are discharged from hospital and sent home with a plan for follow-up treatments. US 2006/0235280 A1 discloses an electronic healthcare management system. The system collects information regarding a patient into a clinical patient record, and uses the record to determine evidence-based recommendations. The system is capable of automatically scheduling follow-up activities when the healthcare provider decides to implement a particular plan. However, the frequency and nature of clinical visits that are planned well in advance may not be tailored to the patient's specific needs.

An example for scheduling a clinical visit on short notice, is scheduling a clinical visit in response to an alert signal from a telehealth monitoring system. Telehealth monitoring systems can track a patient's condition over time and provide warnings when sudden abnormalities or deteriorations occur. A typical follow-up would be to reach out to the patient to arrange a clinic visit or to visit a general practitioner. However, telehealth monitoring systems are currently not used to schedule visits when no immediate exacerbating of the patient condition occurs. Furthermore, emergency clinical visits are obviously not synchronized with other patients having a similar condition.

Hence, there is a clear need to improve the content and timing of the specialist-patient contacts in order to prevent such exacerbations of the patient's condition.

### SUMMARY OF THE INVENTION

It is an object of the present disclosure to provide a healthcare support system and healthcare support method that improve the scheduling of a clinical visit of a patient. It is a further object of the present disclosure to efficiently and effectively plan patient clinical visits and to tailor these visits to the needs of a specific patient.

In a first aspect of the present invention a healthcare support system for scheduling a clinical visit of a patient is presented, the system comprising a processor and a computer-readable storage medium, wherein the computer-readable storage medium contains instructions for execution by the processor, wherein the instructions cause the processor to perform the steps of:

obtaining clinical patient data descriptive of a clinical condition of the patient,

obtaining psycho-social-assessment data of the patient,

scheduling a clinical visit for the patient based on said clinical patient data and said psycho-social-assessment data.

In a further aspect of the present invention a corresponding healthcare support method is presented.

In a further aspect of the present invention a healthcare support system for scheduling a clinical visit of a patient is presented that comprises:

a monitoring device that obtains clinical patient data descriptive of a clinical condition of the patient,

a patient interface for obtaining psycho-social-assessment data of the patient,

a scheduling unit that schedules a clinical visit for the patient based on said clinical patient data and said psycho-social-assessment data.

In yet other aspects of the present invention, there are provided a computer program which comprises program code means for causing a computer to perform the steps of the proposed method when said computer program is carried out on a computer, and a computer-readable non-transitory storage medium containing instructions for execution by a processor, wherein the instructions cause the processor to perform the steps of the claimed healthcare support method.

Preferred embodiments of the invention are defined in the dependent claims. It shall be understood that the claimed method, computer program and computer-readable non-transitory storage medium have similar and/or identical preferred embodiments as the claimed system and as defined in the dependent claims.

Compared to known systems and methods, not only clinical patient data descriptive of a clinical condition of the patient is taken into account, but also psycho-social-assessment data of the patient is considered. Thus, an evidence-based approach for scheduling a clinical visit based on clinical patient data and psycho-social-assessment data is presented. Thereby, the time and content of the clinical visit can be better tailored to the patient's needs which will improve the clinical outcome and quality of life of the patient.

In one aspect the invention provides for a healthcare support system. A healthcare support system as used herein encompasses an automated system which facilitates the scheduling of a clinical visit of a patient. The healthcare support system comprises a processor and a computer-readable storage medium.

A ‘computer-readable storage medium’ as used herein encompasses any storage medium which may store instructions which are executable by a processor of a computing device. The computer-readable storage medium may be referred to as a computer-readable non-transitory storage medium. The computer-readable storage medium may also be referred to as a tangible computer-readable medium. In some embodiments, a computer-readable storage medium may also be able to store data which is able to be accessed by the processor of the computing device. Examples of a computer-readable storage medium include, but are not limited to: A floppy disk, a magnetic hard disk drive, a solid state hard disk, flash memory, a USB thumb drive, Random Access Memory (RAM), Read Only Memory (ROM), an optical disk, a magneto-optical disk, and a register file of the processor. Examples of optical disks include Compact Disks (CD) and Digital Versatile Disks (DVD), for example CD-ROM, CD-RW, CD-R, DVD-ROM, DVD-RW, or DVD-R disks as well as Blue Ray Disks (BD). The term computer-readable storage medium also refers to various types of recording media capable of being accessed by the computer device via a network or communication link. For example, data may be retrieved over a modem, over the internet or over a local area network.

A ‘processor’ as used herein encompasses an electronic component which is able to execute a program or machine executable instruction. References to the computing device comprising ‘a processor’ should be interpreted as possibly containing more than one processor. The term computing device should also be interpreted to possibly refer to a collection or network of computing devices each comprising a processor. Many programs have their instructions performed by multiple processors that may be within the same computing device or which may even be distributed across multiple computing devices.

The term “clinical patient data”, as used herein relates to data descriptive of a clinical condition of the patient. Clinical patient data comprises, for example, vital-sign data such as heart rate, blood pressure, blood oxygen level, respiratory rate, laboratory values, body fat and weight. In general, clinical patient data relates to physical measurement data and can further comprise information about services signed to the patient. This also includes medication of the patient.

The term “psycho-social-assessment data”, relates to data descriptive of one ore more psycho-social aspects. Psycho-social aspects include, but are not limited to, information about the patient's behavior, character, beliefs, education, experiences in life. An example of behavioral aspects are eating habits. Psycho-social-assessment data can be obtained from the patient but also from people that are close to the patient such as family members and friends.

In a further embodiment, the step of obtaining psycho-social-assessment data comprises obtaining self-assessment data of the patient. Preferably, a questionnaire is presented to the patient for obtaining said self-assessment data. Advantageously, the questionnaire is presented to the patient via a web interface on a computer screen. Thereby, the patient can provide psycho-social-assessment data for example from his home instead of at the hectic environment of a hospital ward. Typically, more honest answers are given when psycho-social-assessment data of the patient is gathered in the safe and comfortable environment of the patient's home.

Optionally, the questionnaire for obtaining self-assessment data is dynamically created based upon the obtained clinical patient data. For example, if a clinical parameter indicates that the patient condition deteriorates, a tailored questionnaire can be presented to the patient to investigate potential psycho-social causes. For example, if the weight of the patient increases, as psycho-social cause could be that the patient lost his confidence in his physical abilities and refrains from exercising. It should be noted that a reduced level of exercise could also be identified with conventional patient monitors, for example a patient monitor with an acceleration sensor. However, the psycho-social assessment according to the present disclosure can provide deeper insight into the patient's condition.

In another embodiment, the instructions further cause the processor to perform the step of determining a health status of the patient. According to a first aspect, the health status of the patient is indicative of a clinical condition of the patient based on the obtained clinical patient data. For example, the health status can be represented by a health score, for example, a score from 0 to 1. In a second aspect, the health status further comprises anticipated future developments, such as future adverse events and an life expectancy. In this aspect, the health status can be seen as a combination of a current health status and a future health prognosis.

In yet another embodiment, the instructions further cause the processor to perform the step of obtaining historical patient data. For evidence-based information about the course of a disease, historical patient data can be queried and used for predicting an outcome and future health status of the patient. Data mining techniques can be applied to the obtained historical patient data.

In a further embodiment, the step of scheduling the clinical visit of the patient depends on the determined health of status of the patient. Advantageously, the instructions further cause the processor to perform the step of scheduling the clinical visit if the determined health status falls below a predetermined threshold. Since the health status of the patient not only represents the current condition of the patient but can also comprise a prediction of future adverse events, it is possible to schedule a meeting even before the case of emergency. Thereby, a deteriorating condition or deteriorating outlook can be detected at an early stage such that costly re-admissions or even a visit to the emergency room can be avoided altogether.

According to another embodiment, the instructions further cause the processor to perform the step of tailoring the content of the clinical visit to a clinical need of the patient based on said clinical patient data and/or said psycho-social-assessment data. Currently, clinical visits often follow a standardized procedure wherein a certain set of services is provided to all patients that fall into rather coarse groups of diseases, for example, the group of heart-failure patients. However, in addition to clinical needs based on clinical patient data, for example, requiring the determination of certain laboratory values, the healthcare support system presented herein can also take psycho-social aspects into account. For example, a patient that is well-educated and aware of certain behavioral restrictions that a disease poses upon his lifestyle, does not need to be given advice about certain behavioral restrictions such as a certain type or diet. Thus, there is no need for this patient to see a dietary assistant for consultation during his visit to the hospital. The time and money for this appointment can be saved or alternatively more time spent with patient's for whom an actual need of dietary assistants has been determined.

In a further aspect of this embodiment, in the step of scheduling the clinical visit of the patient, the clinical visit is scheduled such that the clinical visit of the patient coincides with a clinical visit of a second patient with a similar clinical need. Thereby, the efficiency can be improved by organizing group or classroom sessions instead of individual appointments. Optionally, these group or classroom sessions can be followed by individual appointments of reduced duration since much of the disease specific information, but not yet patient specific information, has been given in the group session.

In yet another embodiment of the present disclosure, the instructions further cause the processor to perform the step of computing a therapy recommendation based on said clinical patient data and said psycho-social-assessment data. Thereby, a therapy for the patient can be tailored to the actual patient's needs not only in terms of a clinical condition but also in terms of psycho-social aspects. A ‘therapy’ as used herein comprises all types of intervention and services provided to the patient as well as a pharmaceutical treatment of the patient.

In a further aspect of this embodiment, the instructions further cause the processor to perform the step of determining an effect score based on said psycho-social-assessment data. The effect score assesses, for example, the likeliness of full adherence of the patient to an addressed behavior. In other words, the effect score is a measure that estimates how well a patient sticks or will stick to a proposed cause of treatment. For example, if the psycho-social aspects revealed that the patient is compliant and will follow behavioral recommendations, such as dietary recommendations, a lower level of medication may be required.

### BRIEF DESCRIPTION OF THE DRAWINGS

These and other aspects of the invention will be apparent from and elucidated with reference to the embodiments described hereinafter. In the following drawings

FIG. 1 shows a schematic diagram of a first embodiment of the proposed healthcare support system;

FIG. 2 shows a flow chart of a first embodiment of the proposed healthcare support method;

FIG. 3 shows a schematic diagram of a further embodiment of the proposed healthcare support system;

FIG. 4 shows a flow chart of a further embodiment of the proposed healthcare support system;

FIGS. 5A, B show a first example of a questionnaire for self-assessment;

FIG. 6 shows a second example of a questionnaire for a self-assessment;

FIGS. 7A, B show a third embodiment of a questionnaire for self-assessment.

### DETAILED DESCRIPTION OF THE INVENTION

According to an aspect of the present disclosure, the proposed healthcare support system and method utilize clinical patient data and psycho-social-assessment data for scheduling a clinical visit for the patient.

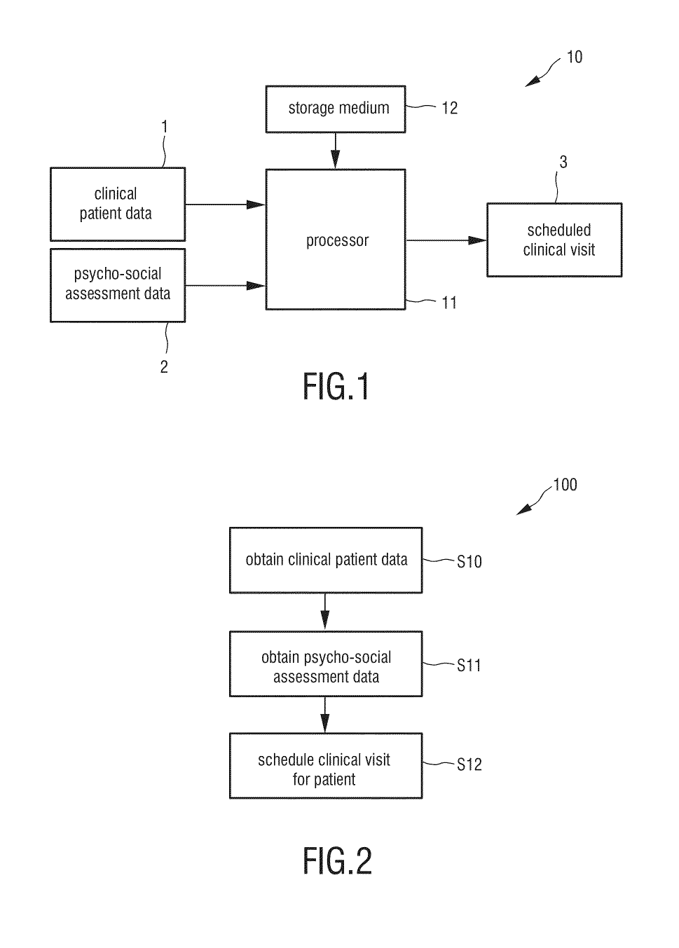

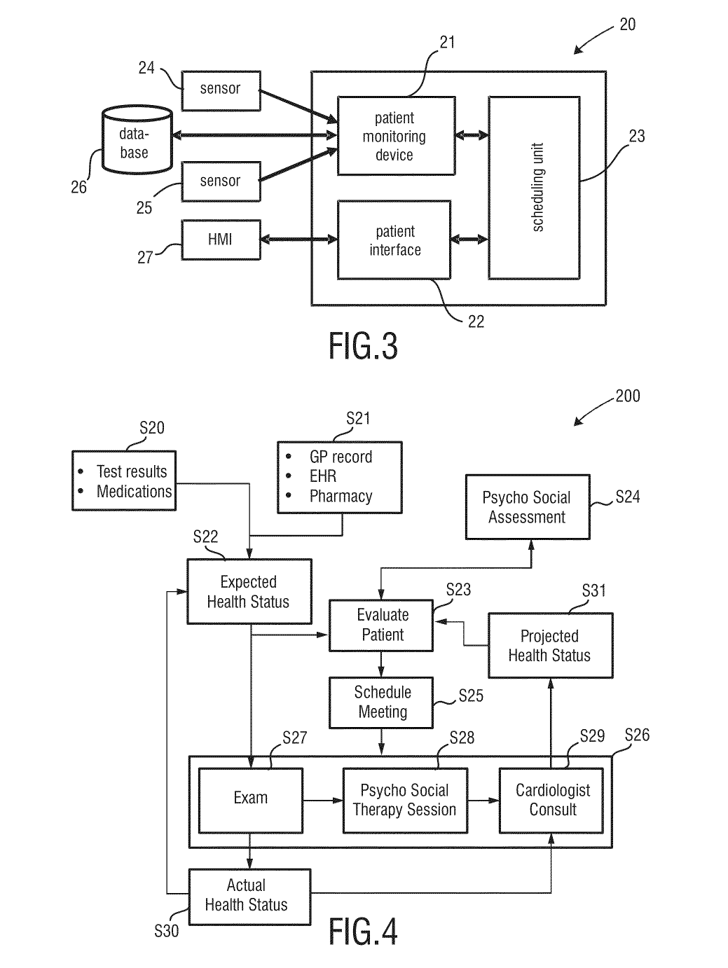

FIG. 1 shows a schematic diagram of a first embodiment of a healthcare support system 10 according to an aspect of the present invention. The system 10 comprises a processor 11 and a computer-readable storage medium 12. The computer-readable storage medium 12 contains instructions for execution by the processor 11. These instructions cause the processor 11 to perform the steps of a healthcare support method 100 as illustrated in the flow chart shown in FIG. 2.

In a first step S10 clinical patient data 1 descriptive of a clinical condition of the patient is obtained. In a second step S11, psycho-social-assessment data 2 is obtained. In a third step S12 a clinical visit 3 for the patient is scheduled based on said clinical patient data 1 and said psycho-social-assessment data 2.

Thus, the scheduling of a clinical visit for the patient not only depends on a clinical condition of the patient but also takes into account psycho-social factors. Patient clinical visits typically have three components: An exam to determine the patient's condition, a session focusing on psycho-social aspects and self-care abilities of the patient and finally a session to determine a clinical treatment. The healthcare support system presented herein discloses an approach where multi-facetted patient data is used to optimally schedule these three components and provide timely decision support. Furthermore, by clustering patients with similar psycho-social therapy needs, the workflow in the clinic can be optimized, for example by offering tailored, yet class-room based, sessions.

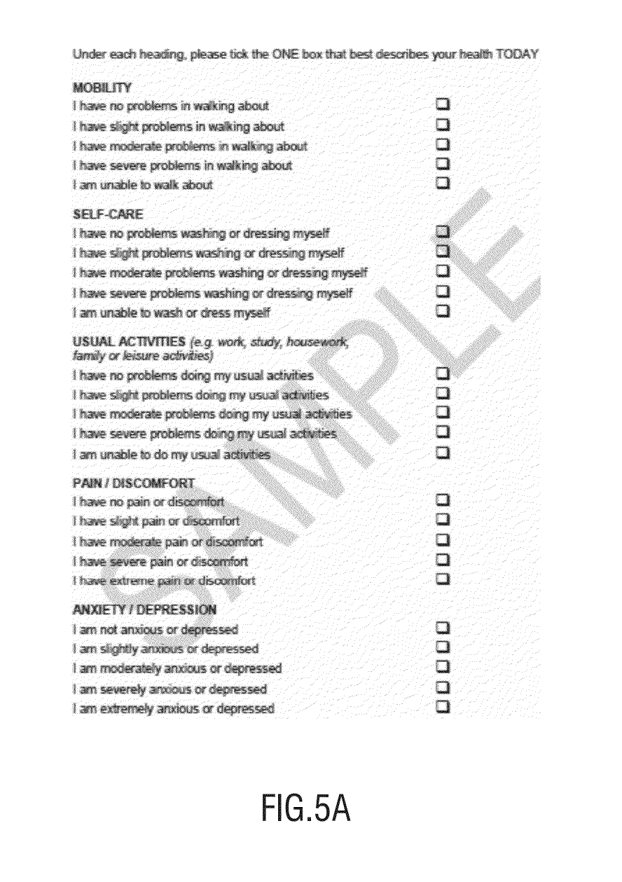

FIG. 3 shows a schematic diagram of a further embodiment of a healthcare support system 20 for scheduling a clinical visit of a patient according to an aspect of the present invention. The system 20 comprises a patient monitoring device 21, a patient interface 22 and a scheduling unit 23.

The patient monitoring device 21 may comprise and/or be connected to one or more sensors for acquiring clinical patient data. For example, the first sensor 24 is a pulse oximeter for determining a heart rate and a blood oxygen level. The second sensor 25 in this example is a weight scale. Furthermore, the patient monitoring device can be connected to a database 26 that contains, for example, an electronic health record (EHR), a record of a general practitioner (GP), records from a pharmacy, laboratory results, information about medication as well as past sensory measurements and examination results from previous clinical visits.

The patient interface 22 further comprises a human-machine interface 27 such as a display, touchscreen, keyboard, voice recognition and the like. The patient interface 22 is used for obtaining psycho-social-assessment data of the patient. For example, the patient interface is a web-based interface that can be presented on a computer screen as the human-machine interface 27.

These scheduling unit 23 schedules a clinical visit for the patient based on the obtained clinical patient data from the patient monitoring device 21 and based on the psycho-social-assessment data obtained via the patient interface 22. The result can be presented to the patient via the patient interface 22. Furthermore, the scheduled clinical visit can be communicated to the respective healthcare provider, for example, the hospital, by the patient monitoring device 21 to a database 26 of the hospital. Of course, the process of scheduling the clinical visit can already be performed in collaboration with the hospital to optimize resource utilization.

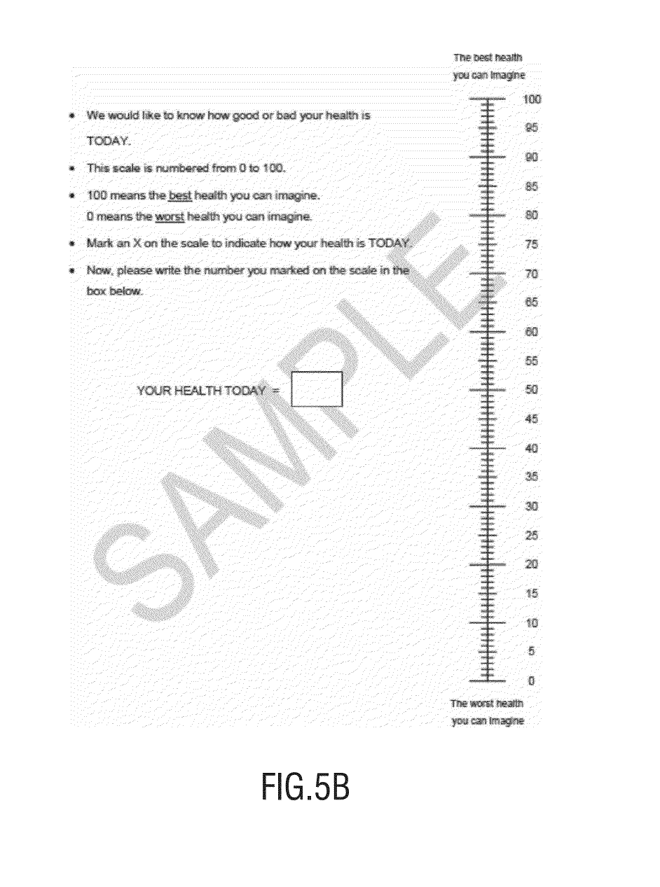

FIG. 4 shows a flow chart of a further embodiment of the proposed healthcare support method 200. In brief, clinical patient data is compared with historic patient profiles from a database to determine a health status of the patient including a prognosis of the future health of the patient. If the health status, in particular the prognosis, is below a threshold, the need for a clinical visit is determined. Based on the disease conditions of the patient, a dynamic patient psycho-social-assessment is presented to the patient, in order to detect issues for example with self-care behavior. The clinical visit is subsequently tailored to the needs of the patient by catering for psycho-social therapy. Thus, scheduling the clinical visit can relate to determining the right point in time and/or content of a clinical visit. The assessment and anticipated outcome of the psycho-social therapy are used to present decision support information to a treating clinician. An anticipated level of improvement in self-care can be based on comparisons with historic patient profiles. This so-called effect score is communicated to the clinician, in order to make better educated decisions about the need of changing for example a pharmaceutical treatment of the patient.

An exemplary process will now be explained in more detail with reference to FIG. 4. In an out-patient setting or at home, a patient is monitored using a flexible range of sensor-based solutions. These include devices such as weight scales, blood pressure monitors and blood glucose measurement tools. Home-based clinical data is obtained in step S20. Furthermore, the patient may be profiled using additional tests such as blood laboratory measurements. Additional data can be available from the patient's personal electronic health record, a record from a general practitioner (GP) and data from a pharmacy and further institutions such as a hospital and an out-patient clinic. An electronic health record can also be used to capture a patient's reported health data such as pain and breathlessness. In step S21 such further data sources are obtained from one or more care institutions, including the hospital's electronic health record, the pharmacy's records and the data from the general practitioner. The data obtained in steps S20 and S21 can be referred to as clinical patient data which is descriptive of a clinical condition of the patient. The available clinical patient data is also referred to as the patient profile. However, in the home setting not all potentially relevant diagnostic tests can be performed. Thus, the rich and multi-facetted collection of data from steps S20 and S21 give a rich, yet incomplete profile of the patient's health status. Therefore, the available clinical patient data is evaluated to determine an expected health status in step S22 and to compute an expected health score, wherein the health status of the patient is extrapolated from the patient profile, thus from the measured data available.

As a non-limiting example, the expected health score can be computed as follows:

1. A patient profile is generated using at least some, preferably all data available in the home setting from step S20.

2. The patient profile is enriched with a data from the electronic health record (EHR) from step S21. This additional data, for example, refers to a primary disease, co-morbidities and information about past hospitalizations.

3. The patient profile is further enriched with laboratory results from the general practitioner or clinics from step S21.

4. Optionally, if there is a co-morbidity, data from a care center where this co-morbidity is treated is also obtained in step S21.

5. The patient profile is compared with a repository of historic patient profiles. The historic patient profiles can be thought of as a collection of previous patient profiles. The historic patient profiles can be annotated with their respective health statuses. For example, these historic patient profiles further provide information about an actual health status of the respective patient at a given moment in time. The actual health status is, for example, given as a score from 0 to 1. This actual health status can further be based on future adverse events such as hospitalizations and life expectancy. In these historic records, an earlier mortality and earlier hospitalizations or reduced functional capacity can lower the score.

6. Through mining historic patient profiles, an estimation of the expected health status of the patient can be generated, for example, as an expected health score between 0 and 1.

7. Besides an expected health status of the patient, anticipated test results that are not actually available in the home setting, for example results from an echocardiogram, can be estimated for the patient. Firstly, test results can be estimated based on a peer group of similar historic patients. Secondly, tests can be identified in this peer group that have very diverse outcomes. Thirdly, tests can be identified in the peer group that have high prognostic power regarding the outcome of the health status of the patients. The expected health status and/or expected health score may potentially miss essential data. The missing data can be obtained later in the clinic or hospital.

The expected health status determined in step S22 is subsequently used in step S23 to evaluate the patient's status.

As a non-limiting example, the health status of the patient is evaluated in step S23 according to one of the following options. For this evaluation, the health profile as well as the expected health score are compared with a projected health score and status. The projected health score and status have, for example, been determined in or in response to a previous clinical visit, step S31.

1. If the expected health score determined in step S22, deviates from the projected health score by a predetermined value, then the need for a clinical visit is determined.

2. If the expected health score is decreasing and a rate of change exceeds a predetermined threshold, then the need for a clinical visit is determined.

3. If the expected health score is stable or even improving, but one or more of parameters with high prognostic power for the health score are deteriorating or are below a predetermined threshold, then the need for a clinical visit is determined.

If the need for a clinical visit has been determined, the following two actions are performed:

1. Psycho-social-assessment data of the patient is obtained in step S24. For example, a patient questionnaire is presented to assess potential causes of the deterioration. Based on the patient's disease and co-morbidities, relevant self-care behaviors can be evaluated. The questionnaire is intended to assess whether there is a clinical need or psycho-social cause to the patient's deterioration and further to assess the nature of the potential psycho-social cause.

Advantageously, the questionnaire is already tailored to the expected and/or projected health status of the patient such that only questions of high prognostic power have to be answered. Thereby, since the patient's attention is focused on a limited set of questions better answers can be expected.

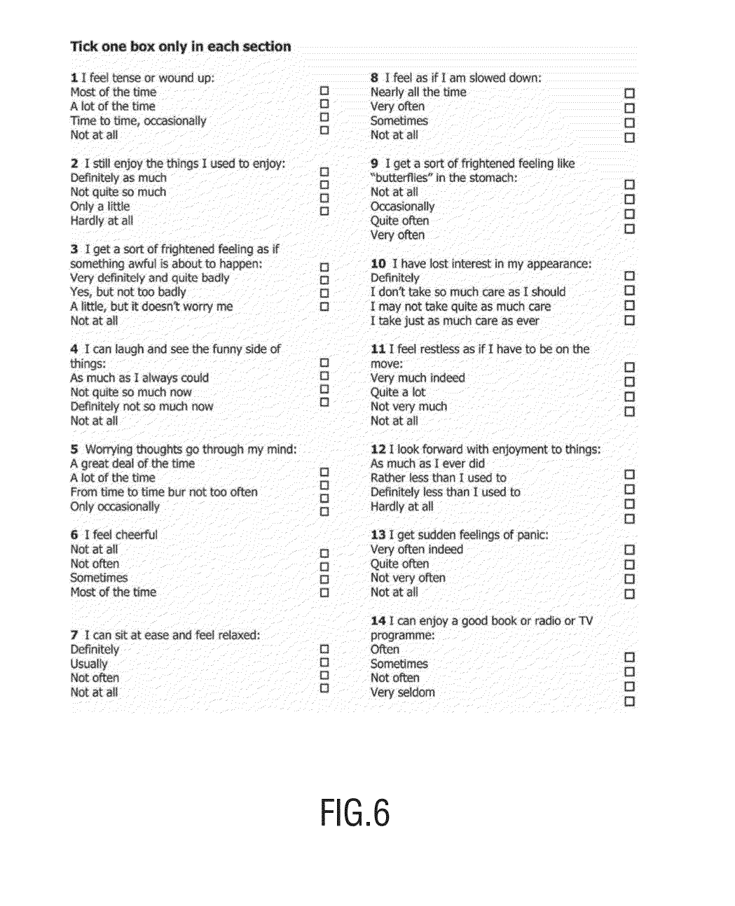

Examples of questionnaires for psycho-social-assessment are shown in FIGS. 5A to 7B and will be referred to further below.

2. Based on the expected health score representative of the patient's expected health status, a meeting in the medical facility, for example, a clinic, is automatically scheduled in step S25. Optionally, a prioritization can be performed by treating patients with lower scores with higher urgency. The exact scheduled date and time can be based on the outcome of the psycho-social assessment. Furthermore the content of the clinical visit can be based on the outcome of the psycho-social assessment. For example, 0 or more self-care behaviors that need to be addressed to prevent further deteriorations and/or early readmissions or mortality can be determined. To increase the efficiency, these behaviors may be discussed in individual sessions, group sessions or a mixed set-up. Patients with similar needs for psycho-social therapy can be clustered for allowing a targeted therapy for a plurality of patients with similar needs.

The scheduled clinical visit S26 typically comprises three steps S27 to S29. Firstly an examination S27 to assess the patient's health status, secondly the afore-mentioned psycho-social therapy session in step S28 and lastly a consultation with a specialist, for example a cardiologist, in step S29. Any data collected by the proposed healthcare support system can be presented to the clinical specialist for evidence-based decision support for a therapy which is tailored to the patient's needs.

A non-limiting example of a clinical visit S26 is described in the following.

1. Based on computations in any of the previous steps, in particular step S22, wherein the expected health status of the patient is computed, important diagnostic tests are scheduled. In particular, tests for which the test results that have been estimated and/or missing tests that have high prognostic power can be scheduled.

2. The results of these tests can be compared with results in the group of historic patients with similar profiles. This comparison can be presented to the clinical specialist later in step S29.

3. Based on the patient profile and additional tests from step S27, an actual health score representative of an actual health status of the patient can be computed in step S30. This can be done in a similar way as the computation in step S22 for determining the expected health status of the patient. However, the examination results of step S27 can be taken into account. Thus, an enriched patient profile can be used to compute a more accurate value for the patient's actual health status.

4. Furthermore, the outcome of the psycho-social therapy can be predicted. Using the information gathered from the patient, i.e. the actual health status S28 and the psycho-social-assessment S24, an effect score can be computed that assesses the likeliness of full or partial adherence of the patient to an addressed behavior. The effect score can be represented similar to the health score as a value between 0 and 1. The effect score is based on the effect of a same or similar therapy to similar patients in the historic database. The effect score is obtained by comparing the patients' health scores before and after an intervention with patients who did not receive or adhere to the therapy.

5. For the specialist consult in step S29, the clinical specialist can be provided with at least one of the following information:

(a) a difference between the expected health score from step S22 and the actual health score from step S30,

(b) a difference between the expected and the actual exam results from step S27,

(c) the effect score of the offered psycho-social therapy,

(d) a projected health score S31 for the period after the specialist consult, given the current health status, the current medication regimen and an anticipated effect of the psycho-social therapy in S28.

If the projected health score S31 is below a predetermined threshold, a recommendation for change in the pharmaceutical treatment can optionally be suggested to the clinical specialist. Furthermore, differences under (a) and (b) that exceed a second threshold can lead to recommendations for a more intensive follow-up schedule because the course of the patient's condition is not well-predictable.

6. A new projected health score can be computed in step S31 based on an adjusted new therapy plan. This can be done by profiling the patient as if the new treatment had been implemented and comparing this profile with the database of historic patient profiles. This projected health score from step S31 can be optionally fed to step S22 to monitor and to compare the patient's condition, for example for monitoring a course of a disease in a home situation.

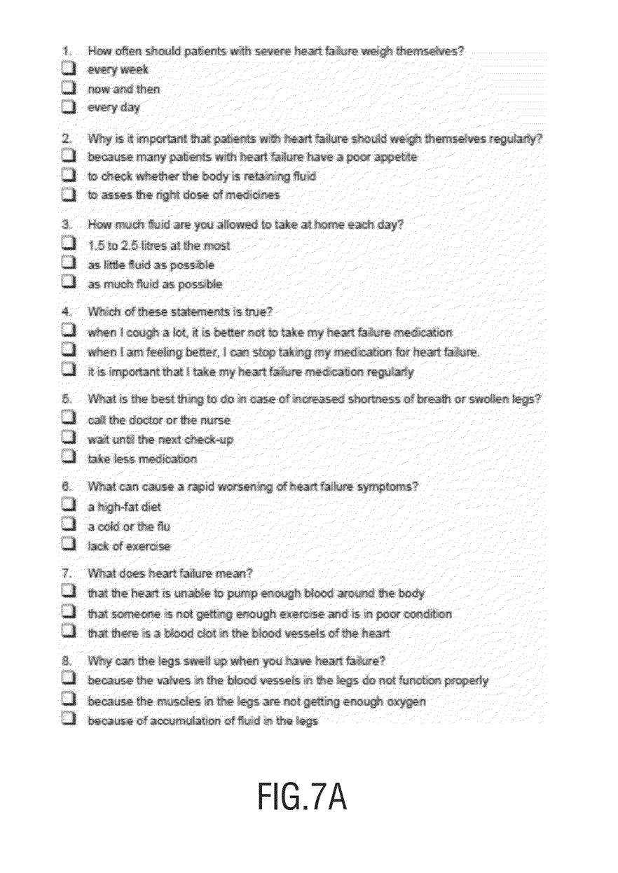

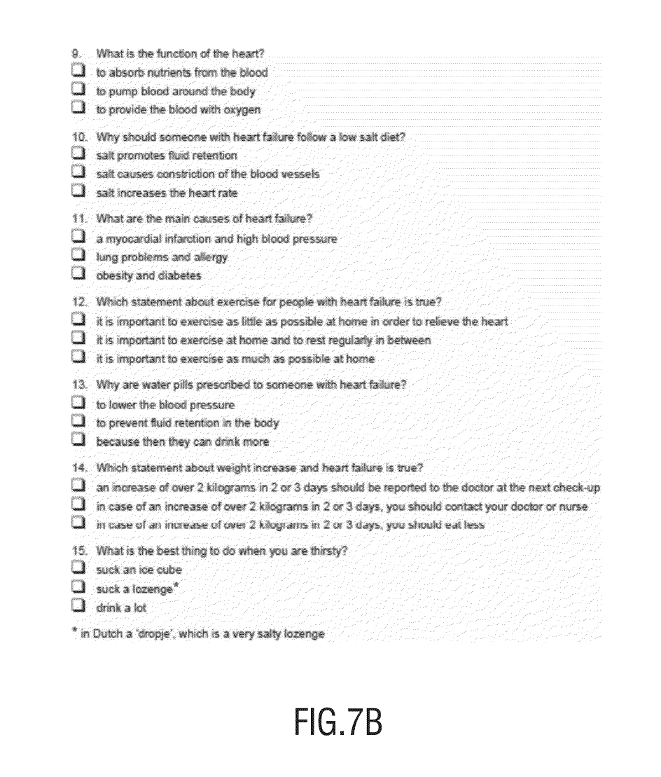

FIGS. 5A and 5B show a first example of a questionnaire that can be presented to the patient for obtaining self-assessment data for psycho-social-assessment. Instead of relating to measurement data descriptive of a clinical condition of the patient, such as blood pressure and weight, this questionnaire determines the psycho-social well-being of the patient. FIG. 6 and FIGS. 7A and 7B show alternative examples of questionnaires.

As a further example of a questionnaire the patient is presented with several statements and has to select from the following answers: I strongly agree; I agree; I neither agree nor disagree; I agree; I strongly disagree. Exemplary statements presented to the patient can be

1. I weight myself every day;

2. If I get shortness of breath I take it easy;

3. If leg/feet are more swollen I contact doctor or nurse;

4. If I gain weight I contact doctor or nurse;

5. I limit the amount of fluids;

6. If I experience fatigue I contact doctor or nurse;

7. I eat low salt diet;

8. I take my medication as prescribed;

9. I exercise regularly.

For example, the health status of a heart failure patient has deteriorated. The diet of the patient can be identified as possible a reason if the patient has given a wrong answer to questions number 7, “I eat low salt diet” or to question number 10. in FIG. 7B “Why should someone with heart failure follow a salt diet?”. In this case, the topic of low-salt diet can be put on the agenda for the psycho-social therapy session in step S28 in FIG. 4.

The answers to such questionnaires can provide psycho-social-assessment date. The result of the psycho-social-assessment, not only helps to investigate potential causes of a deterioration, but can also be used to tailor the patient's clinical visit to the patient's needs. Further examples of tests for obtaining psycho-social-assessment data are the hospital anxiety and the depression scale, the heart failure knowledge questionnaire or the Berlin Sleep questionnaire.

Referring again to FIG. 4, the psycho-social-assessment data of step 24, as well as the expected health status in step S22 and optionally the projected health status S24 as well as the patient evaluation in step S23 can be used in the schedule meeting block S25 to determine the need of a clinical visit, the urgency of a clinical visit and the nature of this visit in terms of required procedures and tests, topics to be discussed and professionals to be seen.

In summary, clinical visits by combining clinical patient data and psycho-social-assessment data, the need, timing and nature of a clinical visit can be determined and a tailored clinical visit can be scheduled. Advantageously, self-assessment data is used. Thereby, the healthcare support system and method improve the quality, effectiveness and efficiency of the clinical visit.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Furthermore, the different embodiments can take the form of a computer program product accessible from a computer usable or computer readable medium providing program code for use by or in connection with a computer or any device or system that executes instructions. For the purposes of this disclosure, a computer usable or computer readable medium can generally be any tangible device or apparatus that can contain, store, communicate, propagate, or transport the program for use by or in connection with the instruction execution device.

In so far as embodiments of the disclosure have been described as being implemented, at least in part, by software-controlled data processing devices, it will be appreciated that the non-transitory machine-readable medium carrying such software, such as an optical disk, a magnetic disk, semiconductor memory or the like, is also considered to represent an embodiment of the present disclosure.

Further, a computer usable or computer readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example, without limitation, physical or wireless.

A data processing system or device suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories, which provide temporary storage of at least some computer readable or computer usable program code to reduce the number of times code may be retrieved from bulk storage during execution of the code.

Input/output, or I/O devices, can be coupled to the system either directly or through intervening I/O controllers. These devices may include, for example, without limitation, keyboards, touch screen displays, and pointing devices. Different communications adapters may also be coupled to the system to enable the data processing system to become coupled to other data processing systems, remote printers, or storage devices through intervening private or public networks. Non-limiting examples are modems and network adapters and are just a few of the currently available types of communications adapters.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different advantages as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated. Other variations to the disclosed embodiments can be understood and effected by those skilled in the art in practicing the claimed invention, from a study of the drawings, the disclosure, and the appended claims.

1. A healthcare support system for scheduling a clinical visit of a patient, the system comprising a processor and a computer-readable storage medium, wherein the computer-readable storage medium contains instructions for execution by the processor, wherein the instructions cause the processor to perform the steps of:
obtaining clinical patient data descriptive of a clinical condition of the patient,
obtaining psycho-social-assessment data of the patient,
scheduling a clinical visit for the patient based on said clinical patient data and said psycho-social-assessment data.

2. The healthcare support system as claimed in claim 1,
wherein the step of obtaining psycho-social-assessment data comprises obtaining self-assessment data of the patient.

3. The healthcare support system as claimed in claim 2,
wherein a questionnaire is presented to the patient for obtaining said self-assessment data.

4. The healthcare support system as claimed in claim 1,
wherein the instructions further cause the processor to perform the step of determining a health status of the patient.

5. The healthcare support system as claimed in claim 1,
wherein the instructions further cause the processor to perform the step of obtaining historical patient data.

6. The healthcare support system as claimed in claim 4,
wherein the step of scheduling the clinical visit of the patient depends on the determined health status of the patient.

7. The healthcare support system as claimed in claim 6,
wherein the instructions further cause the processor to perform the step of scheduling the clinical visit if the determined health status falls below a predetermined threshold.

8. The healthcare support system as claimed in claim 1,
wherein the instructions further cause the processor to perform the step of tailoring the content of the clinical visit to a clinical need of the patient based on said clinical patient data and/or said psycho-social-assessment data.

9. The healthcare support system as claimed in claim 8,
wherein, in the step of scheduling the clinical visit of the patient, the clinical visit is scheduled such that the clinical visit of the patient coincides with a clinical visit of a second patient with a similar clinical need.

10. The healthcare support system as claimed in claim 1,
wherein the instructions further cause the processor to perform the step of computing a therapy recommendation based on said clinical patient data and said psycho-social-assessment data.

11. The healthcare support system as claimed in claim 10,
wherein the instructions further cause the processor to perform the step of determining an effect score based on said psycho-social-assessment data.

12. A healthcare support method for scheduling a clinical visit of a patient comprising the steps of:
obtaining clinical patient data descriptive of a clinical condition of the patient,
obtaining psycho-social-assessment data of the patient,
scheduling a clinical visit for the patient based on said clinical patient data and said psycho-social-assessment data.

13. A computer-readable non-transitory storage medium containing instructions for execution by a processor, wherein the instructions cause the processor to perform the steps of the method as claimed in claim 12.

14. A computer program comprising program code means for causing a computer to carry out the steps of the method as claimed in claim 12 when said computer program is carried out on the computer.

15. A healthcare support system for scheduling a clinical visit of a patient comprising:
a monitoring device that obtains clinical patient data descriptive of a clinical condition of the patient,
a patient interface for obtaining psycho-social-assessment data of the patient,
a scheduling unit that schedules a clinical visit for the patient based on said clinical patient data and said psycho-social-assessment data.
